(19) United States
(12) Patent Application Publication
(10) Pub. No.: US 2015/0360303 A1
(43) Pub. Date: Dec. 17, 2015

(54) FORMING ROTARY CUTTING TOOL

(71) Applicant: MITSUBISHI HEAVY INDUSTRIES, LTD., Tokyo (JP)

(72) Inventor: Takao FURUKAWA, Tokyo (JP)

(73) Assignee: MITSUBISHI HEAVY INDUSTRIES, LTD., Tokyo (JP)

(21) Appl. No.: 14/655,574

(22) PCT Filed: Jan. 20, 2014
(86) PCT No.: PCT/JP2014/050890

§ 371 Date: Jun. 25, 2015

(30) Foreign Application Priority Data
Feb. 28, 2013 (JP) 2013-039998

(51) Int. Cl. B23C 5/18; B23C 5/10

(52) U.S. Cl. CPC B23C 5/18; B23C 5/10; B23C 2210/084; B23C 2210/088; B23C 2215/44; B23C 2220/366

(57) ABSTRACT

A forming rotary cutting tool (1) in the shape of a Christmas tree, provided with a main body (10) and cutting blades (20a, 20b) provided to the outer periphery of the main body (10), the cutting blades (20a, 20b) alternately having a plurality of convex parts (21a₁-21a₄, 21b₁-21b₄) and a plurality of concave parts (22a₁-22a₃, 22b₁-22b₃); wherein within a predetermined range from a tool tip part (30), the cutting blades (20a, 20b) are integrated cutting blades (40a, 40b) that are formed integrally with the main body (10), and outside of the predetermined range, and the cutting blades (20a, 20b) are attached cutting blades (50a, 50b) that are formed separately from the main body (10) and attached to the main body (10).

### TECHNICAL FIELD

The present invention relates to a forming rotary cutting tool in a shape of a Christmas tree.

### BACKGROUND ART

Forming rotary cutting tools are tools that can cut a special shape including curves or straight lines of a workpiece. Among them, a forming rotary cutting tool that is used for machining a blade base part of a turbine blade or a groove of a turbine disc has a shape of a Christmas tree and a contour thereof has a complex shape including irregularities.

The forming rotary cutting tool having such a shape of the Christmas tree has a plurality of lines of cutting blades on an outer periphery around an axis thereof and each cutting blade is formed such that a blade tip diameter is gradually reduced while the blade tip diameter is increased and decreased toward a tool tip side. Thus, the forming rotary cutting tool is rotated around the axis and is moved in a direction orthogonal to the axis, and thereby it is possible to cut a workpiece the same shape as that of a contour in the shape of the Christmas tree in the forming rotary cutting tool. Such a forming rotary cutting tool of the related art is, for example, disclosed in PTL 1.

PTL 1 relates to a technique in which cutting is performed at an optimum cutting speed according to a blade tip diameter of a forming rotary cutting tool, a convex cutting blade part and a concave cutting blade part in the shape of the Christmas tree are constituted by materials of two different types, and wear resistance of the cutting blade part of which the maximum blade tip diameter is large is prevented from being lowered compared to that of the cutting blade of which the maximum blade tip diameter is small.

In the technique described in PLT 1, since different tool material types are respectively selected for the cutting blades of which the cutting tips have different diameters, it is possible to suppress shortening of life of the cutting tool or defect of the tool, and the like due to mismatch of the tool material types and cutting speeds, and to improve machining efficiency.

### CITATION LIST

### Patent Literature

[PTL 1] Japanese Patent Application Publication No. 2009-274173

### SUMMARY OF INVENTION

### Technical Problem

In order to improve cutting performance of the forming rotary cutting tool, if the separate blade is applied as illustrated in PLT 1, an attaching space and a attaching seat for the separate blade are formed by machining a main body in a machining part of the forming rotary cutting tool, and an excess thickness part of the main body is used as a backup for the cutting blade.

However, in a small-sized forming rotary cutting tool or a small-diameter part (in the vicinity of a tool tip side) of the forming rotary cutting tool, if the attaching space and the attaching seat for attaching the separate blade are formed by machining the main body of the forming rotary cutting tool, the main body becomes thin and the excess thickness part for using as the backup for the cutting blade becomes small. Thus, there is a concern that strength as the forming rotary cutting tool or strength as the backup for the cutting blade is lowered, and cutting conditions and the like need to be alleviated.

The present invention is made in view of the problem described above and an object of the invention is to suppress a decrease in strength of a forming rotary cutting tool while ensuring cutting performance as the forming rotary cutting tool.

### Solution to Problem

A forming rotary cutting tool in a shape of a Christmas tree according to a first invention to solve the problem described above including: a main body; and cutting blades provided to an outer periphery of the main body, in which the cutting blades alternately have a plurality of convex parts of which blade tip diameters are changed to be convex along a direction of a tool axis and a plurality of concave parts of which blade tip diameters are changed to be concave along the direction of the tool axis, in which the maximum blade tip diameter in each convex part is gradually reduced toward a tool tip part and the minimum blade tip diameter in each concave part is gradually reduced toward the tool tip part, and in which within a predetermined range from the tool tip part, the cutting blades are integrated cutting blades that are formed integrally with the main body, and outside the predetermined range, the cutting blades are attached cutting blades that are formed separately from the main body and attached to the main body.

In the forming rotary cutting tool of a second invention to solve the problem described above, according to the forming rotary cutting tool of the first invention, the predetermined range is a range from the tool tip part to a vertex in a second convex part.

In the forming rotary cutting tool of a third invention to solve the problem described above, according to the forming rotary cutting tool of the first or second invention, the predetermined range is a range from the tool tip part to a portion in which the blade tip diameter can be 15 mm or less.

In the forming rotary cutting tool of a fourth invention to solve the problem described above, according to the forming rotary cutting tool of any one of the first to third inventions, if a plurality of lines of cutting blades are provided, a boundary between the integrated cutting blade and the attached cutting blade in the cutting blade of at least one line of the plurality of lines of cutting blades is set in a different position with respect to a boundary between the integrated cutting blade and the attached cutting blade in the other cutting blade in a direction along a tool axis.

### Advantageous Effects of Invention

In the forming rotary cutting tool according to the first invention, since it is not necessary to provide an attaching space or an attaching seat, and the like for attaching the separate blades to a tip side of the cutting blade having a small diameter in the forming rotary cutting tool in the shape of the Christmas tree by integrally forming the tip side of the cutting blade with the main body in the forming rotary cutting tool in the shape of the Christmas tree, it is possible to ensure strength as the forming rotary cutting tool without a concern that the main body becomes thin.

Furthermore, it is possible to make the attached cutting blades be formed by a material having cutting performance more excellent than that of the integrated cutting blades and to improve the cutting performance as the forming rotary cutting tool by forming the body other than the tip end of the cutting blades as the separate body from the main body and by attaching the separate body to the main body in the forming rotary cutting tool in the shape of the Christmas tree.

In the forming rotary cutting tool according to the second invention, the machining of the attaching space or the attaching seat, and the like for attaching the blades of the separate body is not performed in the tool leading end of the forming rotary cutting tool in which a decrease in the strength is concerned with making the range of the integrated cutting blades be a range from the tool tip part to the vertex of the second convex part in the forming rotary cutting tool in the shape of the Christmas tree. Thus, it is possible to suppress a decrease in the strength as the forming rotary cutting tool due to thinning of the main body and there is no concern that the main body is damaged or defected.

Furthermore, even if the forming rotary cutting tool is small, the range of the attached cutting blades that are not the integrated cutting blades, that is, the main body in a further rear side than the vertex of the second convex part from the tool tip part of the forming rotary cutting tool has a small diameter, and the main body becomes thin for machining the attaching space or the attaching seat, and the like to attach the separate blades, the range from the tool tip part to the vertex of the second convex part is made to be the integrated cutting blades and sufficient strength of the main body is ensured. Thus, there is no concern that the main body is damaged or defected.

In the forming rotary cutting tool according to the third invention, the machining of the attaching space or the attaching seat, and the like for attaching the separate blade is not performed in the small diameter part of the forming rotary cutting tool in which a decrease in strength is concerned with making a range of the integrated cutting blade in the forming rotary cutting tool in the shape of the Christmas tree be a range from the tool tip part to a portion in which the blade tip diameter can be 15 mm or less. Thus, it is possible to suppress a decrease in the strength as the forming rotary cutting tool due to thinning of the main body and there is no concern that the main body is damaged or defected.

In the forming rotary cutting tool according to the fourth invention, even if a gap due to the attachment and the like occur between the integrated cutting blades and the attached cutting blades in one line of the cutting blades by setting the boundary between the integrated cutting blades and the attached cutting blades in at least one line of the cutting blades of the plurality of lines of cutting blades to be in a different position with respect to the boundary between the integrated cutting blades and the attached cutting blades in the other cutting blade in a direction along the tool axis, since the integrated cutting blades or the attached cutting blades in the other cutting blade can cut a workpiece, there is no effect on accuracy and the like of a cutting surface in the workpiece.

### BRIEF DESCRIPTION OF DRAWINGS

FIG. 1 is a longitudinal sectional view (sectional view that is taken along arrow lines I-I in FIG. 2) illustrating a forming rotary cutting tool according to a first embodiment.

FIG. 2 is a schematic perspective view illustrating the forming rotary cutting tool according to the first embodiment.

FIG. 3 is a cross-sectional view (cross-sectional view that is taken along arrow lines in FIG. 2) illustrating an attached cutting blade in the forming rotary cutting tool according to the first embodiment.

FIG. 4 is a cross-sectional view (cross-sectional view that is taken along arrow lines IV-IV in FIG. 2) illustrating the integrated cutting blade in the forming rotary cutting tool according to the first embodiment.

### DESCRIPTION OF EMBODIMENTS

Hereinafter, an embodiment of a forming rotary cutting tool according to the invention will be described in detail with reference to the annexed drawings. Of course, the invention is not limited to the following embodiment and it goes without saying that various changes are possible without departing from the scope of the invention.

### First Embodiment

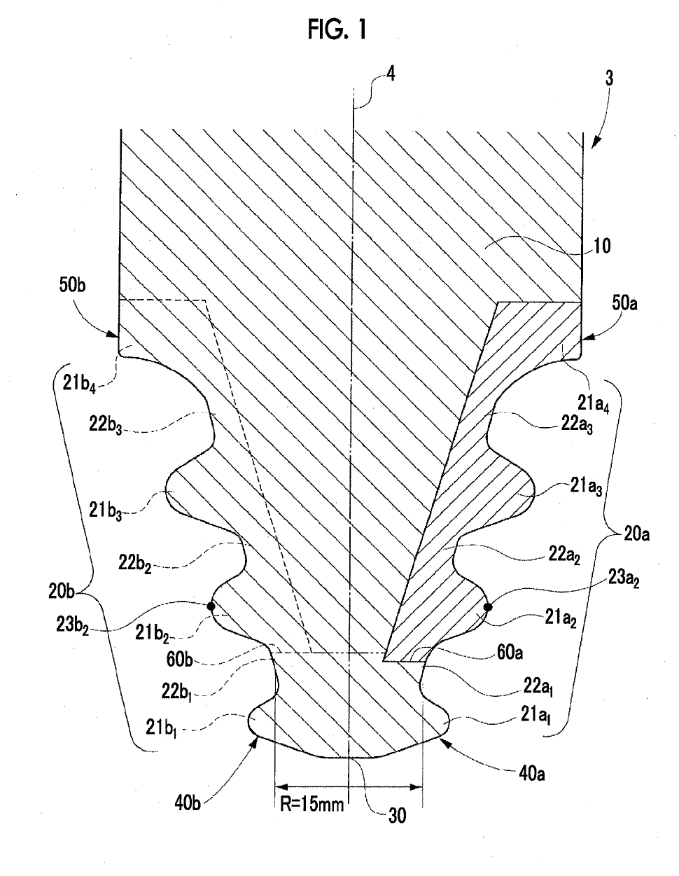

First, a structure of a forming rotary cutting tool according to a first embodiment of the invention will be described with reference to FIGS. 1 to 4.

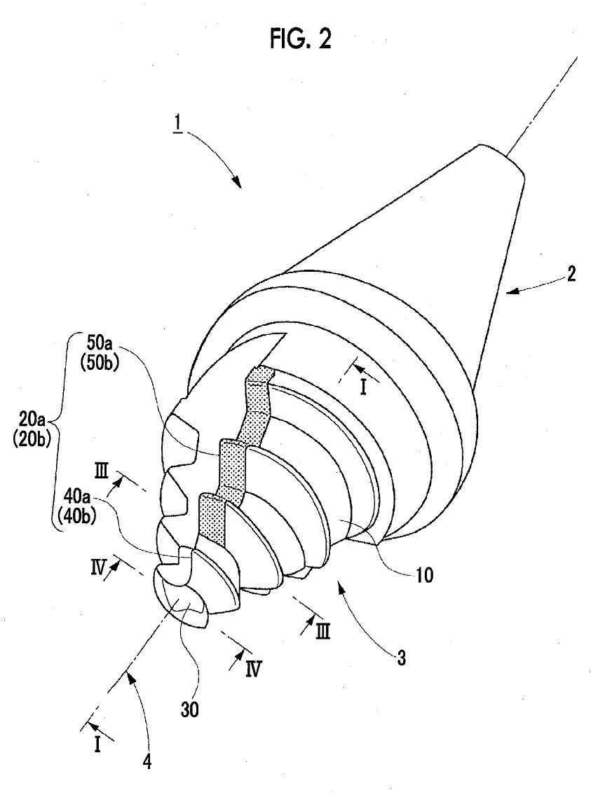

The forming rotary cutting tool according to the embodiment is a tool having a shape of a Christmas tree and, for example, is used for forming a groove in the shape of the Christmas tree for installing moving blades to a turbine shaft. As illustrated in FIG. 2, a forming rotary cutting tool 1 includes a shank part 2 that is attached to a main shaft (not illustrated) of a machine via a tool holder (not illustrated) and a machining part 3 that performs cutting on a workpiece (not illustrated), which are continuously provided on the same axis (tool axis 4). In the forming rotary cutting tool 1, the shank part 2 is gripped by the main shaft (not illustrated) of the machine via the tool holder (not illustrated), is rotated around the tool axis 4, and is moved to a direction perpendicular to the tool axis 4, and thereby the machining part 3 abuts the workpiece (not illustrated) and cutting is performed on the workpiece.

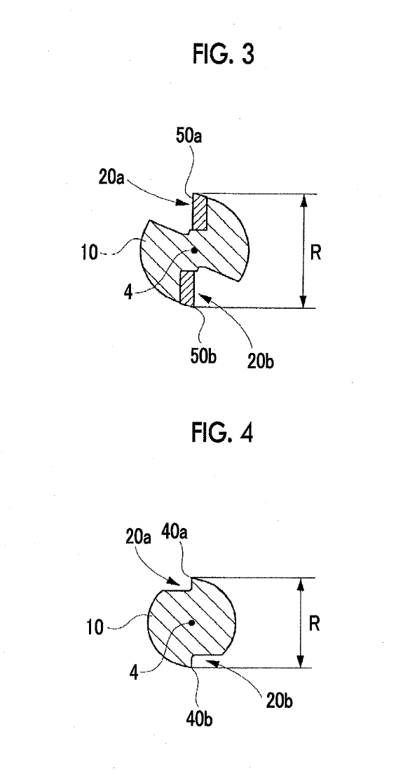

The machining part 3 includes a main body 10 connected to the shank part 2, and integrated or attached cutting blades 20a and 20b with or to the main body 10 provided in a direction along the tool axis 4 on an outer periphery side of the main body 10. As illustrated in FIGS. 3 and 4, the cutting blades 20a and 20b are provided so as to face each other on the outer periphery side of the main body 10, that is, are provided with a phase difference of 180°.

As illustrated in FIG. 1, in the machining part 3, the cutting blades 20a and 20b alternately have a plurality of convex parts 21a₁ to 21a₄ and 21b₁ to 21b₄ of which blade tip diameters R (diameters of circles passing through blade tips of the cutting blades 20a and 20b in a plane perpendicular to the tool axis 4, see FIGS. 3 and 4) are convexly changed along the direction of the tool axis 4, and a plurality of concave parts 22a₁ to 22a₃ and 22b₁ to 22b₃ of which blade tip diameters R are concavely changed along the tool axis 4. The maximum blade tip diameter R in each of the convex parts 21a₁ to 21a₄ and 21b₁ to 21b₄ is formed so as to be gradually decreased toward a tool tip part 30 and the minimum blade tip diameter R in each of the concave parts 22a₁ to 22a₃ and 22b₁ to 22b₃ is formed so as to be gradually decreased toward the tool tip part 30.

Generally, in the forming rotary cutting tool in such a shape of the Christmas tree, the blade tip diameter in the cutting blade is small and strength of the main body is lowered as closer to the tool tip part. Thus, in a small diameter part in a small forming rotary cutting tool or a forming rotary cutting tool, if an attaching space and an attaching seat for attaching a separate blade are machined by machining the main body of the forming rotary cutting tool, since the main body becomes thin and an excess thickness part used as backup of the cutting blade is reduced, the strength as the forming rotary cutting tool is further decreased.

Thus, as illustrated in FIGS. 1 and 2, the forming rotary cutting tool 1 in the embodiment includes integrated cutting blades 40a and 40b integrally formed with the main body 10, and attached cutting blades 50a and 50b attached to the main body 10 by being molded separately from the main body 10 as the cutting blades 20a and 20b in the machining part 3.

That is, a range in which the blade tip diameter R is small in the vicinity of the tool tip part 30 in the machining part 3 is formed by the integrated cutting blades 40a and 40b, and thereby it is not necessary to machine the attaching space or the attaching seat for attaching the separate blade to the main body 10. Thus, it is possible to avoid a decrease in the strength of the main body 10 in the machining part 3 of the forming rotary cutting tool 1 and to maintain sufficient strength as the main body 10 without reducing a cross-sectional area (see FIG. 4) of the main body 10 in the direction perpendicular to the tool axis 4.

In the embodiment, as described above, in order to maintain the strength of the main body 10 and to ensure cutting performance as the forming rotary cutting tool 1, the range in which the integrated cutting blades 40a and 40b is formed in the machining part 3 is made to be a range not exceeding vertexes 23a₂ and 23b₂ in the second convex parts 21a₂ and 21b₂ from the tool tip part 30.

In the forming rotary cutting tool 1 according to the embodiment, as the integrated cutting blades 40a and 40b in the cutting blades 20a and 20b, a high-speed tool steel (HSS) that is a material having both hardness capable of being used in cutting and toughness as a base material of the forming rotary cutting tool 1 is employed and as the attached cutting blades 50a and 50b in the cutting blades 20a and 20b, cemented carbide that is a material of which hardness is especially high and abrasion resistance is excellent is employed.

That is, a range separated from the tool tip part 30 in the machining part 3 in which the blade tip diameter R is great, that is, a range in which sufficient strength can be maintained as the main body 10 even if the attaching space or the attaching seat of the blade described above is machined, is made to be the attached cutting blades 50a and 50b. Thus, since the blade of the cemented carbide excellent in the cutting performance more than the high-speed tool steel is provided, it is possible to ensure sufficient cutting performance as the forming rotary cutting tool 1.

Thus, in order to actively employ the cemented carbide excellent in the cutting performance as the attached cutting blades 50a and 50b of the cutting blades 20a and 20b, the range in which the integrated cutting blades 40a and 40b are formed is made to be a range from the tool tip part 30 to a position that does not exceed the vertexes 23a₂ and 23b₂ in the second convex parts 21a₂ and 21b₂.

Moreover, even if the forming rotary cutting tool 1 is especially small, the range of the attached cutting blades 50a and 50b, that is, the main body 10 in a rear side (upper side in FIG. 1) further than the vertexes 23a₂ and 23b₂ in the second convex parts 21a₂ and 21b₂ from the tool tip part 30 of the forming rotary cutting tool 1 has a small diameter, the main body 10 becomes thin for machining the attaching space or the attaching seat and the like of the blade described above, the range from the tool tip part 30 to the vertexes 23a₂ and 23b₂ in the second convex parts 21a₂ and 21b₂ is made to be the integrated cutting blades 40a and 40b, and the main body 10 maintains sufficient strength. Thus, there is no concern that the main body 10 and the like are damaged and defected.

Furthermore, in the embodiment, in order for the cemented carbide excellent in the cutting performance to be actively employed as the attached cutting blades 50a and 50b of the cutting blades 20a and 20b, the range in which the integrated cutting blades 40a and 40b are formed in the machining part 3 is set to the range from the tool tip part 30 to a portion in which the blade tip diameter R can be 15 mm or less (see FIG. 1).

This is because if the attaching space or the attaching seat is machined for attaching the separate blade to the main body 10 in the portion in which the blade tip diameter R is 15 mm or less in the machining part 3, there is a concern that the cross-sectional area of the main body 10 in the portion is excessively small and sufficient strength cannot be maintained as the main body 10 in the machining part 3 of the forming rotary cutting tool 1.

Moreover, in the embodiment, the attached cutting blades 50a and 50b are attached to the main body 10 by brazing. Of course, a attaching method of the attached cutting blades 50a and 50b in the forming rotary cutting tool 1 according to the invention is not limited to the brazing and the attached cutting blades 50a and 50b may be attached to the main body 10 in the machining part 3 of the forming rotary cutting tool 1 using bolts and the like. Furthermore, the attached cutting blades 50a and 50b may be attached to the main body 10 in the machining part 3 of the forming rotary cutting tool 1 by inserting a copper plate (not illustrated) and the like between the attached cutting blades 50a and 50b, and the main body 10. In this case, a degree of adhesion between the attached cutting blades 50a and 50b, and the main body 10 is increased and thereby attachment strength is improved.

In the embodiment, as illustrated in FIG. 1, on the tip side of the forming rotary cutting tool 1, a boundary 60a between the integrated cutting blade 40a and the attached cutting blade 50a in one cutting blade 20a is set to be in a different position with respect to a boundary 60b between the integrated cutting blade 40b and the attached cutting blade 50b in the other cutting blade 20b in a direction along the tool axis 4.

Thus, for example, even if a gap occurs by inserting the copper plate (not illustrated) and the like described above between the integrated cutting blade 40a and the attached cutting blade 50a in one cutting blade 20a, since the integrated cutting blade 40b or the attached cutting blade 50b in the other cutting blade 20b can cut the workpiece (not illustrated), there. is no influence on accuracy of the cutting surface in the workpiece and the like.

Next, an operation of the forming rotary cutting tool according to the first embodiment of the invention will be described with reference to FIGS. 1 to 4.

The forming rotary cutting tool 1 according to the embodiment is installed on the main shaft (not illustrated) of the machine via the tool holder (not illustrated), is rotated around the tool axis 4, is moved toward the direction perpendicular to the tool axis 4, and abuts the workpiece (not illustrated), and thereby cutting in the shape of the Christmas tree is performed in the workpiece.

In the forming rotary cutting tool 1 according to the embodiment, in order to avoid a decrease in the strength of the main body 10, the range forming the integrated cutting blades 40a and 40b in the machining part 3 is made to be a range from the tool tip part 30 to a position in which the blade tip diameter R can be 15 mm or less, and a range to a position that does not exceed the vertexes 23a₂ and 23b₂ in the second convex parts 21a₂ and 21b₂ from the tool tip part 30.

Thus, in the range in which the blade tip diameter R is small in the vicinity of the tool tip part 30 in the machining part 3, since the machining of the attaching space or the attaching seat for attaching the separate blade to the main body 10 is not performed, the cross-sectional area (see FIG. 4) of the main body 10 is not reduced in the direction perpendicular to the tool axis 4 and the strength of the main body 10 can be ensured in the machining part 3 of the forming rotary cutting tool 1. That is, there is no concern that the forming rotary cutting tool 1 is damaged or defected by the cutting and it is possible to extend the life of the forming rotary cutting tool 1 and to use the forming rotary cutting tool 1 without alleviating cutting conditions.

In the forming rotary cutting tool 1 in the shape of the Christmas tree as the embodiment, the blade tip diameter R is reduced toward the tool tip part 30, therefore, when the rotational operation of the forming rotary cutting tool 1 for cutting the workpiece is performed by attaching the forming rotary cutting tool 1 to the main shaft (not illustrated) of the machine via the tool holder (not illustrated), and since the blade tip diameters R in the convex parts 21a₁ to 21a₄ and 21b₁ to 21b₄, and the concave parts 22a₁ to 22a₃ and 22b₁ to 22b₃ in the cutting blades 20a and 20b are different from each other, peripheral speeds (cutting speeds) thereof are different from each other.

That is, in the cutting by the forming rotary cutting tool 1 in the embodiment, cutting is performed in which the blade tip diameter R is small and the peripheral speed (cutting speed) is slow in the integrated cutting blades 40a and 40b, and cutting is performed in which the blade tip diameter R is great and the peripheral speed (cutting speed) is fast in the attached cutting blades 50a and 50b.

For the high-speed tool steel that is the material for forming the integrated cutting blades 40a and 40b and the cemented carbide that is the material for forming the attached cutting blades 50a and 50b in the cutting blades 20a and 20b of the forming rotary cutting tool 1, the high-speed tool steel is known to be suitable for slow cutting speed as compared to the cemented carbide. That is, in the cutting by the forming rotary cutting tool 1 of the embodiment, the cutting suitable for characteristics of the high-speed tool steel and the cemented carbide that are respectively the materials forming the integrated cutting blades 40a and 40b, and the attached cutting blades 50a and 50b in the cutting blades 20a and 20b is performed.

### REFERENCE SIGNS LIST

1 forming rotary cutting tool

2 shank part

3 machining part

4 tool axis

10 main body

20a, 20b cutting blade

21a₁ to 21a₄, 21b₁ to 21b₄ convex part

22a₁ to 22a₃, 22b₁ to 22b₃ concave part

23a₂, 23b₂ vertex in second convex part from tool tip part

30 tool tip part

40a, 40b integrated cutting blade

50a, 50b attached cutting blade

60a, 60b boundary between integrated cutting blade and attached cutting blade

1. A forming rotary cutting tool in a shape of a Christmas tree comprising:
a main body; and
cutting blades provided to an outer periphery of the main body,
wherein the cutting blades alternately have a plurality of convex parts of which blade tip diameters are changed to be convex along a direction of a tool axis and a plurality of concave parts of which blade tip diameters are changed to be concave along the direction of the tool axis,
wherein the maximum blade tip diameter in each convex part is gradually reduced toward a tool tip part and the minimum blade tip diameter in each concave part is gradually reduced toward the tool tip part, and
wherein within a predetermined range from the tool tip part, the cutting blades are integrated cutting blades that are formed integrally with the main body, and outside the predetermined range, the cutting blades are attached cutting blades that are formed separately from the main body and attached to the main body.

2. The forming rotary cutting tool according to claim 1,
wherein the predetermined range is a range from the tool tip part to a vertex in a second convex part.

3. The forming rotary cutting tool according to claim 1,
wherein the predetermined range is a range from the tool tip part to a portion in which the blade tip diameter can be 15 mm or less.

4. The forming rotary cutting tool according to claim 1,
wherein if a plurality of lines of cutting blades are provided, a boundary between the integrated cutting blade and the attached cutting blade in the cutting blade of at least one line of the plurality of lines of cutting blades is set in a different position with respect to a boundary between the integrated cutting blade and the attached cutting blade in the other cutting blade in a direction along a tool axis.
